(19) United States
(12) Patent Application Publication
(10) Pub. No.: US 2025/0121999 A1
(43) Pub. Date: Apr. 17, 2025

(54) CARTRIDGE FOR SYSTEM AND METHOD FOR RELIABLY DISPENSING PRE-PACKAGED PHARMACEUTICALS

(71) Applicant: SPENCER HEALTH SOLUTIONS, INC., Morrisville, NC (US)

(72) Inventors: James Malone Giarelli, Raleigh, NC (US); Jeffrey J. Schedel, Apex, NC (US); Paul Joseph Cunningham, Hillsborough, NC (US); Daniel McMichael Stipe, Raleigh, NC (US)

(21) Appl. No.: 18/915,758

(22) Filed: Oct. 15, 2024

Related U.S. Application Data
(60) Provisional application No. 63/590,556, filed on Oct. 16, 2023.

(51) Int. Cl. B65D 83/04

(52) U.S. Cl. CPC B65D 83/049

(57) ABSTRACT

A cartridge for pharmaceutical dispensing system, wherein the system is configured to dispense pouches containing medicaments, the pouches provided as a strip of a plurality of pouches, the strip provided in coiled form, includes: a main receptacle having a floor, a ceiling, a front wall, a rear wall, and a first side wall, wherein the front wall includes a slot for dispensing pouches; a cover that engages the main receptacle and provides a second side wall opposite the first side wall; and a guide system disposed in the main receptacle, the guide system defining an interior space configured to hold the strip of pouches in coiled form, and further defining a pathway between the guide system and the ceiling, rear wall, and floor.

### RELATED APPLICATION

The present application claims priority from and the benefit of U.S. Provisional Patent Application No. 63/590,556, filed Oct. 16, 2023, the disclosure of which is hereby incorporated herein by reference in full.

### FIELD OF THE INVENTION

The present invention relates generally to devices for dispensing items, and more specifically, to systems and methods for assisting patients in taking prescription medication, in accordance with a desired regimen prescribed by a physician.

### BACKGROUND OF THE INVENTION

Even with the present day advances in medicines and healthcare, people, especially senior citizens and disabled persons, face a number of challenges in taking care of their health at home. Typically, there is little assistance for the “home patient” in managing multiple prescriptions and inventories of medicines. According to some estimates, the average senior person is prescribed up to thirteen different oral medications that must be taken correctly at different times each day. These medications are typically delivered in bulk supply and must be sorted, managed, and then taken correctly by the individual, leading to numerous errors and omissions, including failing to take the medications at the prescribed time, taking the medications at the wrong time and/or in the incorrect amount, misusing the medications, fatally combining the medications with other medications, under-using the medications, or over-using the medications, collectively referred to “non-compliance.”

The costs associated with such non-compliance are higher than the costs associated with a number of major illnesses. Studies have shown that 10% of admissions to regular hospitals in the United States are due to non-compliance, at a cost of $15 billion a year, and 30% of hospital admissions for people over the age of 65 are directly caused by non-compliance. Non-compliance causes 125,000 deaths per year—twice as many as are caused by auto accidents. Twenty-three percent to forty percent of nursing home admissions are due to noncompliance and inability to take medications at home unsupervised. According to estimates, nearly half of all prescriptions are taken incorrectly, contributing to prolonged or additional illness. People who miss doses need three times as many doctor visits as others and face an average of $2,000 more in medical costs per year.

The fact that the aging population continues to grow, combined with the steady increase in the average number of medications prescribed per person, indicates that these issues will continue to compound along with the associated costs.

In order to ensure that medications are taken at the proper time, a variety of devices, such as those disclosed in U.S. Pat. Nos. 4,361,408 and 7,944,342, have been devised to generate audible and/or visible prompting or alarm signals that remind a patient or his caretaker to administer the correct dosages at the correct time. Various dispensing devices have also been developed to help patients adhere to their medication protocols or regimens. Examples of such devices are provided in U.S. Pat. Nos. 8,060,246 and 8,196,774 and in U.S. Patent Publication Nos. 2016/0355322 and 2018/0086547, the disclosures of each of which are hereby incorporated by referenced herein in full.

The devices described in the latter two publications discuss a dispensing system that relies on a strip of individual pouches, with each pouch including medications to be taken at the same time. The system, offered under the trade name SPENCER® by Spencer Health Solutions (Morrisville, North Carolina), dispenses each pouch at the appointed time, and alerts the patient or caretaker that the time has arrived to take the medication in the pouch. The strip of pouches is provided in the form of a coil or roll housed in a cartridge that can easily be inserted into the machine and replaced when the pouches are exhausted.

It may be desirable to provide additional designs for cartridges that can facilitate their use with the dispensing system.

### SUMMARY OF THE INVENTION

As a first aspect, embodiments of the invention are directed to a cartridge for pharmaceutical dispensing system, wherein the system is configured to dispense pouches containing medicaments, the pouches provided as a strip of a plurality of pouches, the strip provided in coiled form. The cartridge comprises: a main receptacle having a floor, a ceiling, a front wall, a rear wall, and a first side wall, wherein the front wall includes a slot for dispensing pouches; a cover that engages the main receptacle and provides a second side wall opposite the first side wall; and a guide system disposed in the main receptacle, the guide system defining an interior space configured to hold the strip of pouches in coiled form, and further defining a pathway between the guide system and the ceiling, rear wall, and floor.

As a second aspect, embodiments of the invention are directed to a cartridge for pharmaceutical dispensing system, wherein the system is configured to dispense pouches containing medicaments, the pouches provided as a strip of a plurality of pouches, the strip provided in coiled form. The cartridge comprises: a floor, a ceiling, a front wall, a rear wall, and first and second sidewalls, wherein the front wall includes a slot for dispensing pouches; and a guide system disposed in the main receptacle, the guide system defining an interior space configured to hold the strip of pouches in coiled form, and further defining a pathway between the guide system and the ceiling, rear wall, and floor. The guide system includes a round-ended bulb at an upstream end thereof.

### BRIEF DESCRIPTION OF THE FIGURES

FIG. 1 is a perspective view of a pharmaceutical dispensing system according to embodiments of the invention.

FIG. 2 is a perspective view of the system of FIG. 1 with one side wall removed to the cartridge compartment and drive wheels.

FIG. 3 is a perspective view of a cartridge to be used with the system of FIG. 1.

FIG. 4 is a perspective view of the main receptacle of the cartridge of FIG. 3.

FIG. 5 is a side view of the receptacle of FIG. 4.

FIG. 6 is a partial perspective view of the lower portion of the receptacle of FIG. 4.

FIG. 7 is a partial front view of the lower portion of the receptacle of FIG. 4.

FIG. 8 is a partial side perspective view of the brake of the cartridge of FIG. 3.

FIG. 9 is a partial front perspective view of the slot in the front wall of the cartridge of FIG. 3.

FIG. 10 is a perspective view of the cover of the cartridge of FIG. 3.

FIG. 11 is a side view of the main receptacle of FIG. 4 with a schematic representation of a coiled strip of pouches shown therein.

FIG. 12 is a partial side view of the lower portion of the main receptacle and strip of FIG. 11.

FIG. 13 is a perspective view of a cartridge to be used with the system of FIG. 1 according to alternative embodiments of the invention.

FIG. 14 is a perspective view of the main receptacle of the cartridge of FIG. 13.

FIG. 15 is a side view of the receptacle of FIG. 14.

FIG. 16 is a partial perspective view of the lower portion of the receptacle of FIG. 14.

FIG. 17 is a partial front view of the lower portion of the receptacle of FIG. 14.

FIG. 18 is a partial side perspective view of the brake of the cartridge of FIG. 13.

FIG. 19 is a partial front perspective view of the slot in the front wall of the cartridge of FIG. 13.

FIG. 20 is a perspective view of the cover of the cartridge of FIG. 13.

FIG. 21 is a side section view of the system of FIG. 1 with the cartridge of FIG. 13 inserted therein.

FIG. 22 is a side view of the main receptacle of FIG. 14 with a schematic representation of a coiled strip of pouches shown therein.

FIG. 23 is a partial side view of the lower portion of the main receptacle and strip of FIG. 22.

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

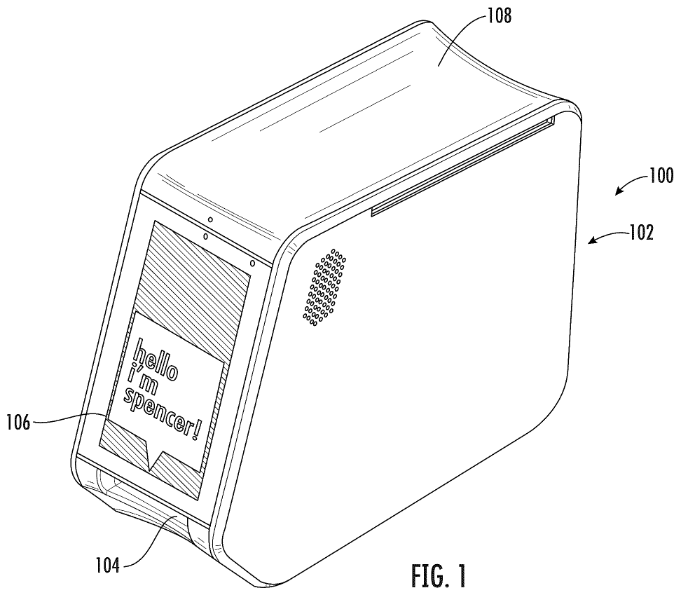

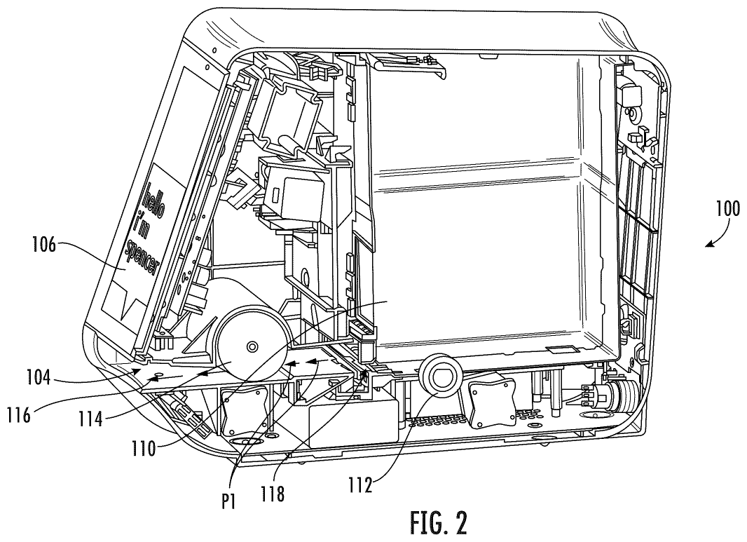

Referring now to the drawings, a pharmaceutical dispensing system, designated broadly at 100, is shown in FIG. 1. The system 100 includes a generally box-shaped housing 102 with a dispensing window 104. A display screen 106 is located above the dispensing window 104 and provides an interface for the user to interact with the system 100. A door 108 is located on the top of the housing 102 and provides access to a cartridge compartment 110 (see FIG. 2) located on the interior of the housing 102.

Referring now to FIG. 2, is a side cutaway view of the system 100, it can be seen that the cartridge compartment 110 is located toward the rear of the housing 102 and below the door 108. A drive wheel 112 is located below and extends into the cartridge compartment 110. Another drive wheel 114 is located forwardly of the cartridge compartment 110 above a platform 116. The platform 116 leads to the dispensing window 104. A slot 118 is present in the lower front portion of the cartridge compartment 110 just above the platform 116. Thus, a pathway P1 (indicated by arrows in FIG. 2) is formed between the interior of the cartridge compartment 110 and the dispensing window 104 along the platform 116.

Operation of the system 100 is described in some detail in U.S. Patent Publication Nos. 2016/0355322 and 2018/0086547, supra, and need not be described in great detail therein. In summary, a cartridge filled with a coiled strip of pouches, each of the pouches containing medicaments to be taken at a single time, is loaded into the cartridge compartment 110. A controller (not shown) signals the system 100 when a pouch should be dispensed. When the user requests dispensing, the drive wheels 112, 114 drive the pouch at the downstream end of the strip along the pathway P1 and through the dispensing window 104 so that the pouch can be accessed by the user. The system 100 then waits to receive another signal from the controller when the next pouch is to be dispensed. Greater detail about the operation of the system 100 may be found in the above-listed patent publications and at spencerhealthsolutions.com.

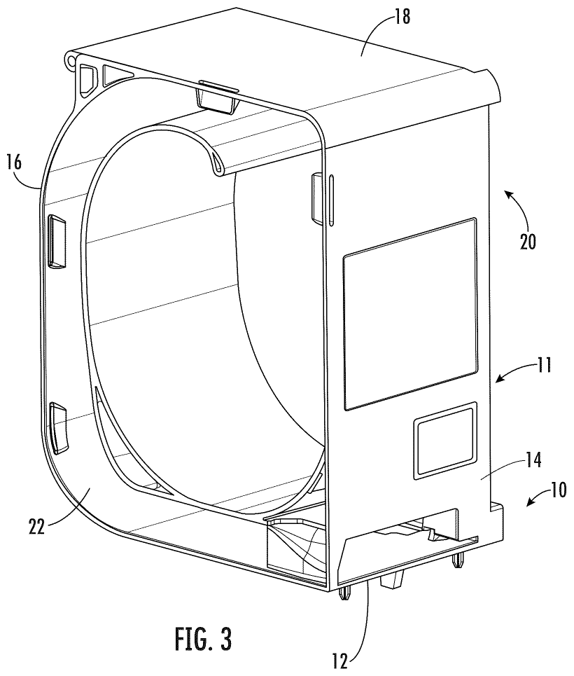

Referring now to FIGS. 3-10, an improved cartridge for use with the system 100 is shown therein. The cartridge, designated broadly at 10, is generally box shaped and is configured to fit within the cartridge compartment 110 of the system 100. The cartridge 10 is generally rectangular, with a main receptacle 11 having a floor 12, a front wall 14, a rear wall 16, a ceiling 18 and a sidewall 20. A separate cover 22 provides a sidewall opposite the sidewall 20. The receptacle 11 and the cover 22 are described in greater detail below.

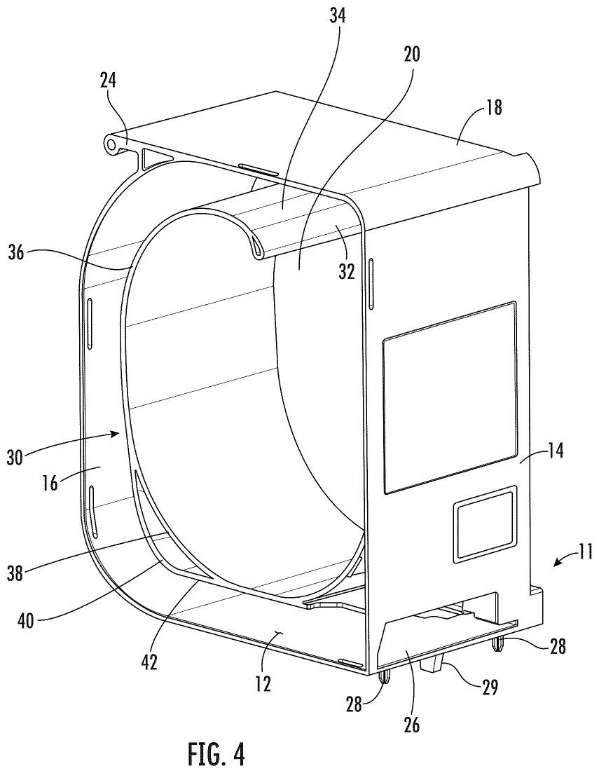

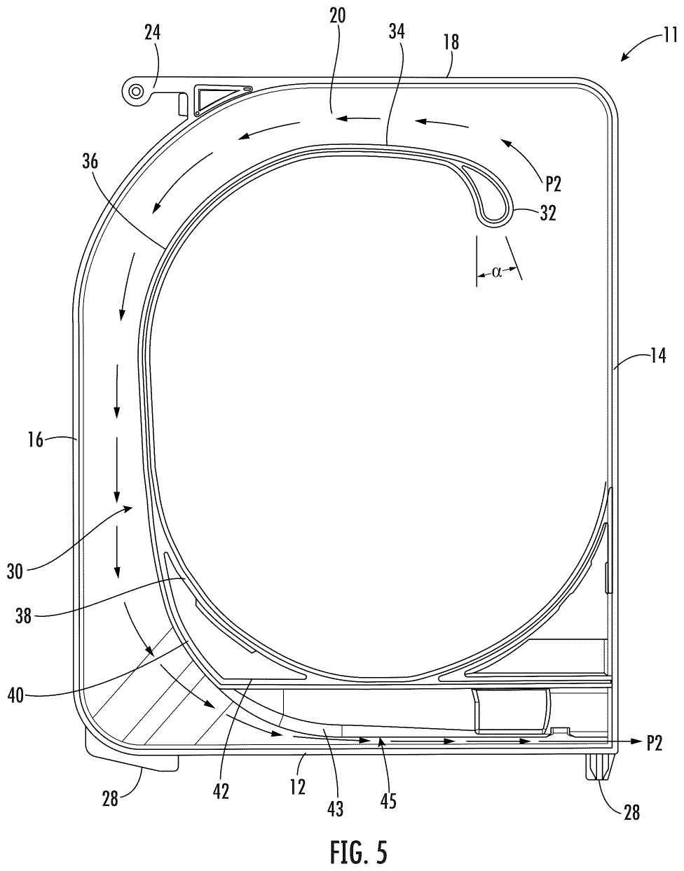

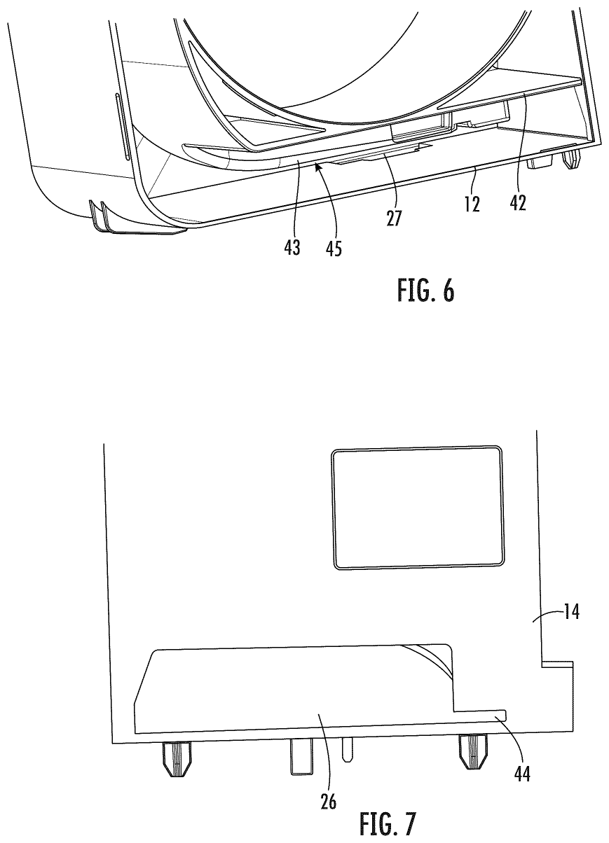

As shown in FIGS. 4 and 5, the floor 12, the front wall 14, the rear wall 16, the ceiling 18 and the sidewall 20 describe generally a box. The ceiling 18 includes a small flange 24 that extends rearwardly and provides a handle for the cartridge 10. The front wall 14 includes a slot 26 at its lower end. As shown in FIGS. 6 and 9, the floor 12 includes an offset T-shaped slot 27 near its side edge. Protrusions 28 extend downwardly from the floor 12 to provide location points for mounting of the cartridge 10 in the cartridge compartment 110. A protrusion 29, which also extends downwardly from the floor 12, is positioned to activate a switch in the system 10 that indicates that a cartridge has been loaded into the system 10.

Within its interior, the main receptacle includes a guide system 30. Generally, the guide system 30 describes an arc that is approximately 250 to 300 degrees, with one end of the arc originating from a central portion of the inner surface of the front wall 14 and extending clockwise (from the vantage point of FIG. 5) to terminate below a front portion of the ceiling 18 rearwardly of the front wall 14. In some embodiments, the guide system 30 follows generally a Fibonacci spiral. As shown in FIG. 5, the guide system 30 forms a pathway P2 (indicated with arrows in FIG. 5) with the ceiling 18, the rear wall 16 and the floor 12 through which a strip of medicament-filled pouches can travel.

Focusing on the specifics of the guide system 30, the free end of the guide system 30 includes a round-ended teardrop-shaped bulb 32 that extends forwardly and downwardly; the bulb 32 is disposed at an angle a of between about 0 and 90 degrees relative to vertical, with 30 to 60 degrees being typical. The rounded end of the bulb 32 can have a radius of between about 0.1 and 1 inch. A short, straight segment 34 extends horizontally and rearwardly from the rear end of the bulb 32. An upper arcuate section 36 extends rearwardly and downwardly from the straight segment 34. At the lower end of the upper arcuate section 36, the guide system 30 divides into a lower arcuate segment 38 and a transition wall 40. The lower arcuate segment 38 extends forwardly and downwardly, then forwardly and upwardly, from the lower end of the upper arcuate segment 36; overall, the lower arcuate segment extends over approximately 180 degrees. The transition wall 40 is located rearwardly of the lower arcuate segment 38 and is curved slightly. A pathway ceiling 42 extends horizontally and forwardly from the lower end of the transition wall 40 to meet the front wall 14 just above the slot 26; the pathway ceiling 42 is generally parallel to the floor 12.

In addition, referring to FIGS. 5 and 6, the guide system 30 includes a bearing member 43 that merges with and extends first forwardly and from the transition wall 40, then extends forwardly parallel to but below the pathway ceiling 42 to form a gap 45 with the floor 16. The bearing member 43 projects inwardly only a short distance from the sidewall 20 (it extends inwardly approximately the same distance as the “wings” of the T-shaped slot 27). The bearing member 43 extends forwardly to the front wall 14, and in doing so forms the upper limit of a slit 44 that is contiguous with the slot 26 (see FIG. 7).

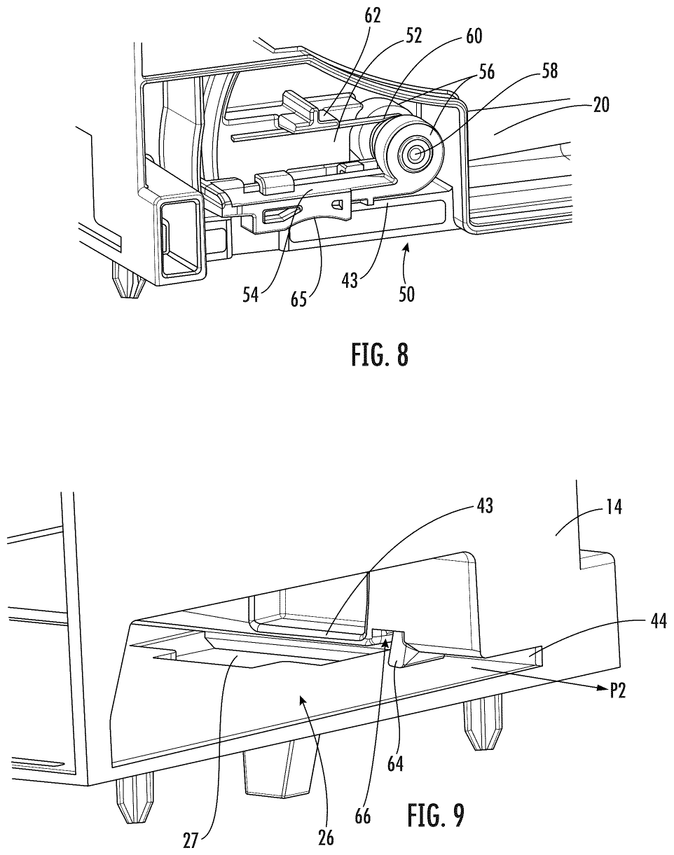

Referring now to FIGS. 8 and 9, a brake 50 is located in a pocket 52 on the outside of the sidewall 20 near the front lower corner thereof, wherein the upper and lower surfaces of the pocket 52 are defined by the pathway ceiling 42 and the bearing member 43. The brake 50 has an arm 54 that extends from two pivot bosses 56. The pivot bosses 56 are mounted on and pivot relative to a post 58 in the pocket 52. A spring 60 encircles the post 58 and engages the arm 54 and a flange 62 within the pocket 52 to bias the arm 54 of the brake 50 downwardly. A finger 64 extends inwardly and downwardly from the arm 54; the finger 64 extends through a small slot 66 in the bearing member 43 and into the pathway P2 above the T-shaped slot 27. The arm 54 includes a recess 65 on its lower surface to assist with manual manipulation of the arm 54.

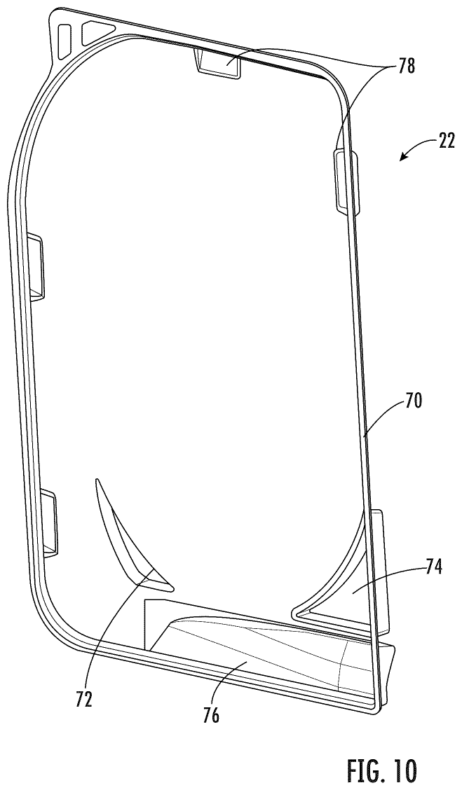

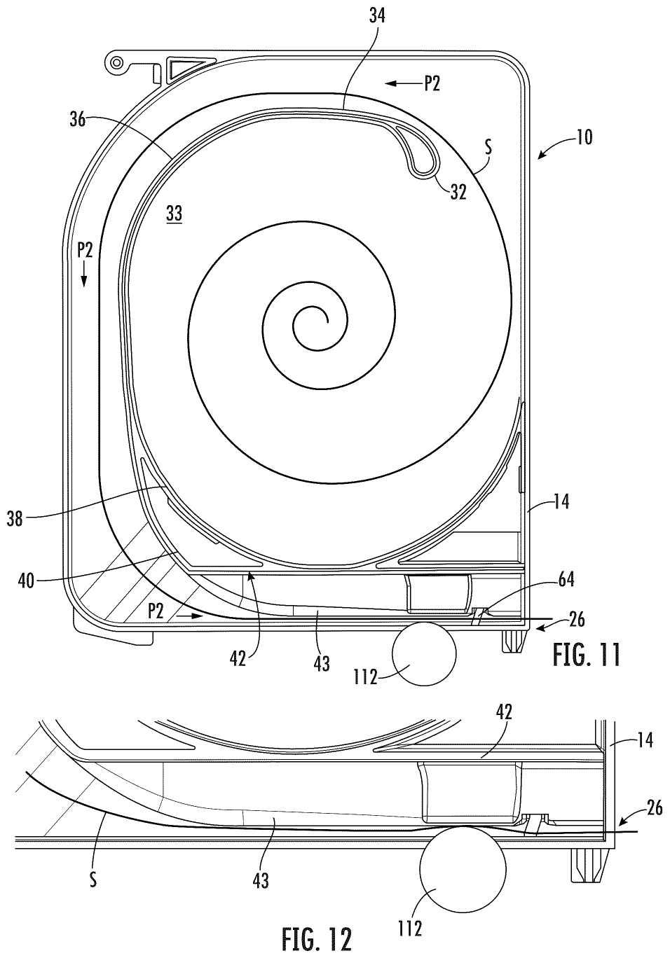

Referring now to FIG. 10, the cover 22 is generally flat, with a raised rim 70 that lines the perimeter of the cover 22. Indentations 72, 74, 76 are present to nest within spaces created by the guidance system 30. The cover 22 also includes several tabs 78 around its perimeter that are received within slots in the main receptacle 11 to secure the cover 22 to the receptacle 11.

As can be seen in FIG. 11, to prepare a cartridge 10, a strip of pouches S, each filled with medicaments to be administered at a given time, is coiled and inserted into the main receptacle 11. The bulk of the coiled strip S is positioned within an interior space 33 defined by the bulb 32, the straight segment 34, the upper arcuate section 36, and the lower arcuate segment 38. The “downstream” end of the strip S is threaded along the pathway P2; i.e., the downstream end is routed in front of, then above, the bulb 32, above the straight section 34, behind the upper arcuate segment 36, behind the transition wall 40, and forwardly below the pathway ceiling 42. The edge of the strip S (which may be a flattened seam) is inserted into the gap 45 between the bearing member 43 and the floor 16. The edge of the strip S overlies the drive wheel 112 and underlies the bearing member 43, such that the drive wheel 112 can use the bearing member 43 to create friction with the strip S needed to drive the strip S. The arm 54 of the brake 50 is raised to allow the downstream end of the edge of the strip S to be inserted between the finger 64 and the floor 14. When the arm 54 is at rest, the finger 64 engages and presses downwardly to force the strip S against the floor 16, causing it to remain in position (typically the braking force is between about 0.75 and 2 lbs.). The downstream end of the strip S is then routed through the slot 26 so that it can be accessed by a user, and the cover 22 is snapped into place over the receptacle 11 via the tabs 78.

The process of preparing a cartridge 10 described above is typically performed by a pharmacist in a pharmacy (e.g., a commercial pharmacy, a mail order pharmacy, a hospital or other care facility, etc). Once prepared, the cartridge 10 loaded with a strip S can be provided to a patient that owns or otherwise has access to a system 100. The cartridge 10 can be loaded into the system 100 by opening the door 108 located on the top of the housing 102 and lowering the cartridge 10 into the cartridge compartment 110. The cartridge 10 should be oriented so that the slot 14 faces forwardly (i.e., toward the display screen 106 and the dispensing window 104). Alignment of the cartridge 10 can be facilitated by the protrusions 28 of the floor 12. The drive wheel 112 extends upwardly through the T-shaped slot 27 to engage the lower surface of the strip S. The user then closes the door 108. This action signals the controller that the cartridge 10 has been loaded and the system 100 is ready for use.

In operation, the system 100 indicates (e.g., through a visual reminder on the display screen 106, an audible signal, or the like) that the time for a pouch to be dispensed has arrived. The user responds to the prompt by requesting dispensing of the next pouch in the strip S. The controller releases the brake 50 (i.e., causes it to pivot to raise the arm 54, thereby raising the finger 64 from the strip S) and drives the drive wheels 112, 114 to advance the strip S forwardly through the slot 44. The system 100 slices the forwardmost pouch from the strip S and drives the pouch forwardly along the pathway P1 to the dispensing window 104, where it can be retrieved by the user.

The cartridge 10 includes a number of improvements over prior cartridges that can be used with the system 100. First, the cartridge 10 lacks a central hub, axle or other centrally-located component that facilitates uncoiling of the strip S. The absence of an axle/hub can reduce cost and simplify loading of the pouch into the cartridge 10. In addition, the absence of an axle/hub can reduce the tension force require to unroll the strip during operation.

Second, the presence of the bulb 32 at the end of the guide system 30 can facilitate smooth travel of the strip S from the interior space 33 into the pathway P2. In some instances, some pouches may contain large and/or irregularly shaped pills. Such pills can have a tendency to get caught or hung up on the upstream-most edge of the guide system 30. Such “catching” can occur to both pouches that are in the outermost coil of the strip S as it is coiled within the interior space 33 and pouches in the leading portion of the strip S that is routed onto the pathway P2. In both instances, the rounded end of the bulb 32 can help pouches slip past the bulb without catching. Similarly, the aforementioned angular disposition of the bulb 32 can assist in directing the outermost coil of the strip S to be routed into the pathway P2 while directing the next outermost coil of the strip S to remain in the interior space 33.

Third, the main receptacle 11 and cover 22 can render the loading of the strip S easier. Some prior embodiments of cartridges had a clamshell-style configuration, which could be somewhat difficult to load. Because the main receptacle 11 includes the full width of the front wall 14, floor 12, ceiling 18 and rear wall 16, the coiled strip S of pouches can be easily dropped into place in the main receptacle, at which point the leading portion of the strip S can be easily routed along the pathway P2 and into the gap 45, where it can be captured by the brake 50. Also, the recess 65 in the arm 54 of the brake 50 can also assist the user in manipulating the brake 50 during loading. Once the strip S of pouches is loaded, the cover 22 can be snapped into place.

The receptacle 11 and cover 22 may be formed of any suitable material, but in some embodiments are formed of a polymeric material such as acrylonitrile-butadiene-styrene (ABS), high density polyethylene (HDPE), polyethylene terephthalate (PET), or high impact polystyrene (HIPS) (which may include a low friction additive). Notably, the main receptacle 11 is configured so that it can be easily injection-molded, with limited “side-action” mechanisms in the mold. The cover 22 may be thermoformed from an extruded sheet of a polymeric material, such as PET. Also, by being formed of a polymeric material rather than a less durable material such as cardboard, the cartridge 10 may be re-used.

Those of skill in this art will appreciate that the cartridge 10 may take other forms. For example, in some embodiments a clamshell-type configuration may be employed for the housing, with the guide system being mounted to both halves of the clamshell. In some embodiments the brake 50 may take a different configuration (e.g., it may be positioned to apply upwardly-directed pressure to the strip from underneath rather than downwardly-directed pressure from above, or it may be biased to an unbraked position rather than a braked position). Also, in some embodiments the brake may be detachable.

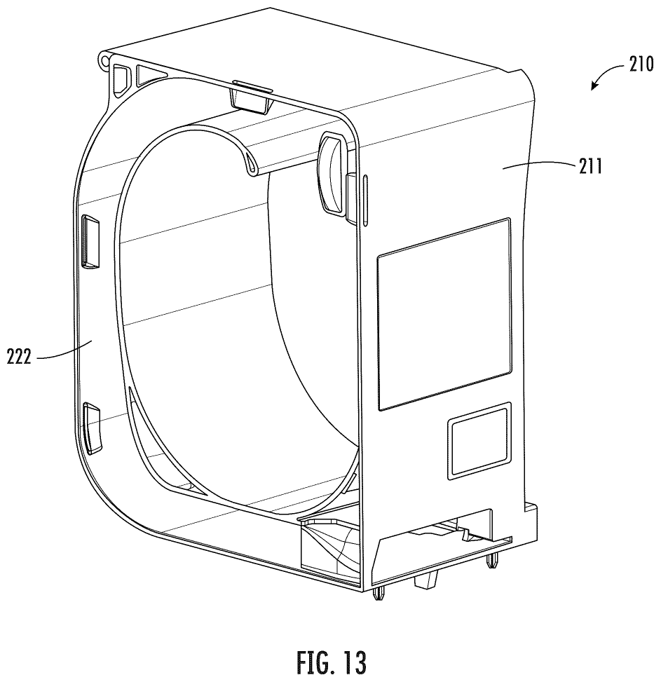

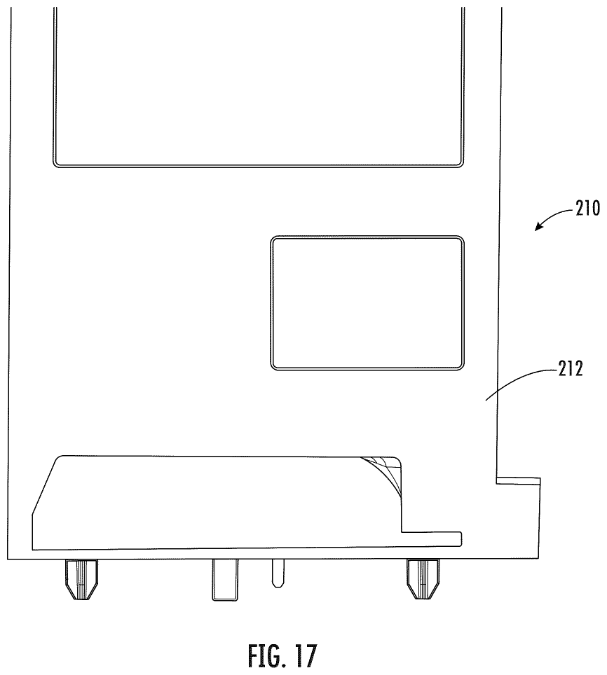

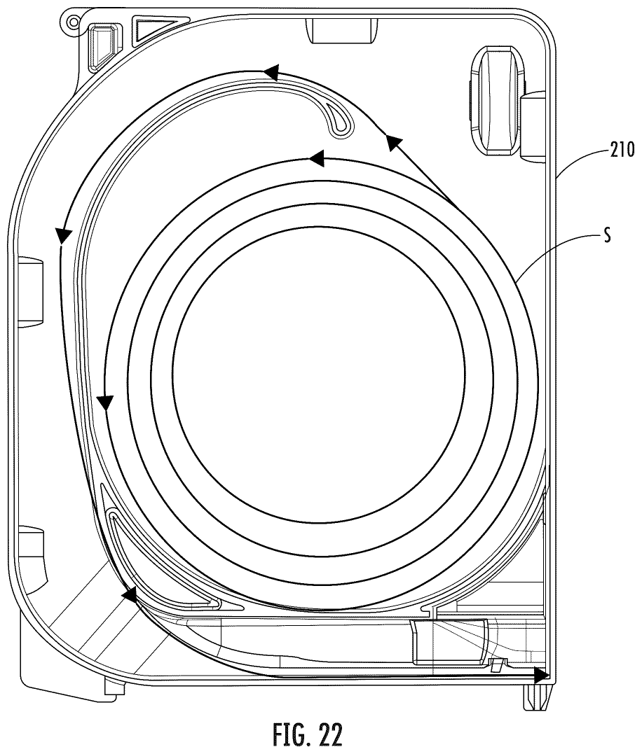

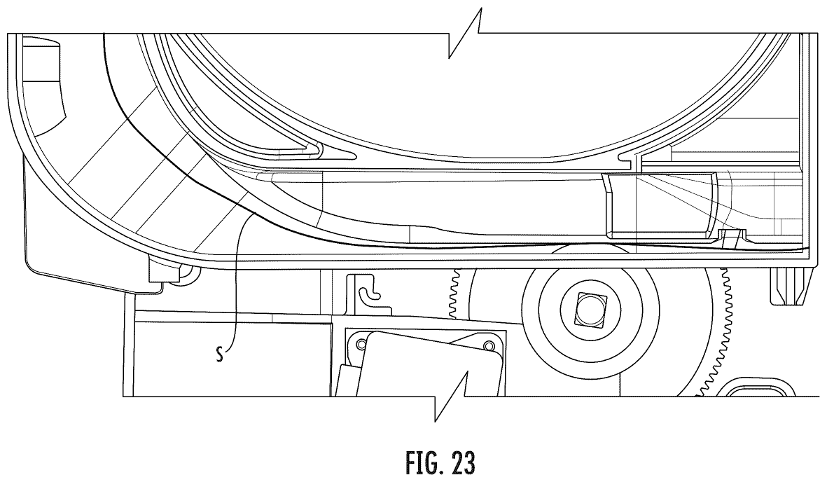

In addition, the guide system 30 may be configured differently. Some potential differences are illustrated in FIGS. 13-23, in which another embodiment of a cartridge is shown and designated at 210. Much of the cartridge 210 is the same as or similar to the cartridge 10; differences in the cartridges 10, 210 (which include modifications to the guide system 230) are discussed below.

Referring now to FIG. 13, it can be seen that the bulb 232 of the guide system 230 is somewhat smaller than the bulb 32, such that its lower end is raised slightly, and its position is shifted rearwardly. The radius of the rounded end of the bulb 232 is between about 0.1 and 1 inch. With the bulb 232 so configured and located, more room is present between the front wall 214, the ceiling 218, and the bulb 232 for pouches that contain a number of larger pills, and there may be less of a tendency for any of the pouches to “catch” or “snag” on the bulb 232 after contact.

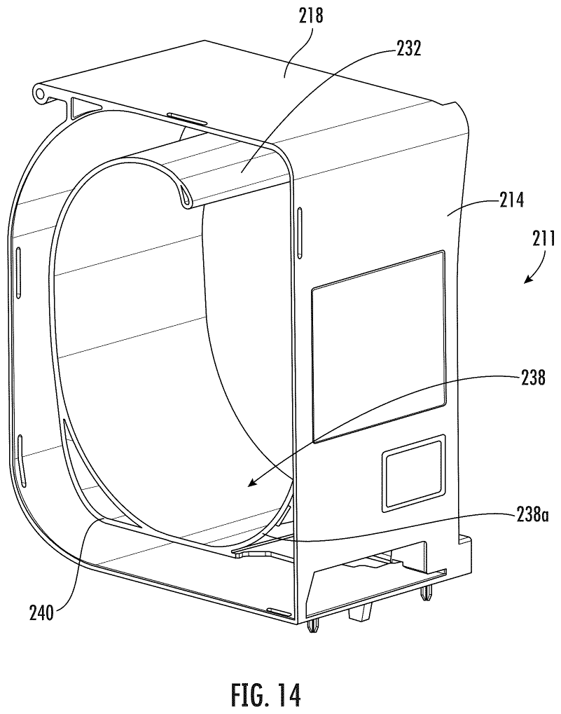

Referring now to FIG. 14, it can be seen that the forward portion 238a of the lower arcuate segment 238 is shifted forwardly slightly and is slightly less rounded than the arcuate segment 38. This modification can help to provide additional room for coiled strips of pouches, thereby potentially allowing slightly larger coils (i.e., with more pouches) than can be received by the cartridge 10. Also, as a result, the overall arc defined by the upper and lower arcuate segments 236, 238 is approximately 270 degrees. The guide system 230 may still follow a Fibonacci spiral.

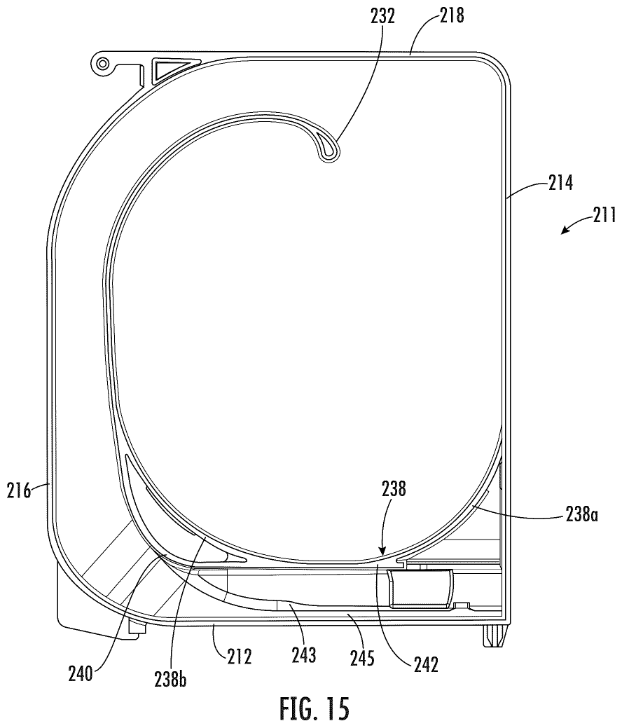

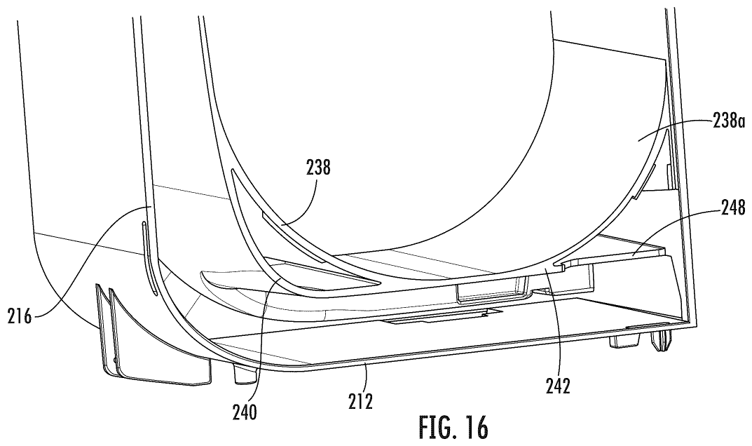

Referring now to FIGS. 15 and 16, the rear portion 238b of the lower arcuate segment 238 was also modified, in this instance to raise the rear portion slightly as the path of the lower arcuate segment 328 transitions from vertical to horizontal. Also, the corner between the rear wall 216 and the floor 212 is more rounded. Both of these changes can assist in preventing pouches from snagging or catching as they proceed toward the gap 245 between the bearing member 243 and the floor 212.

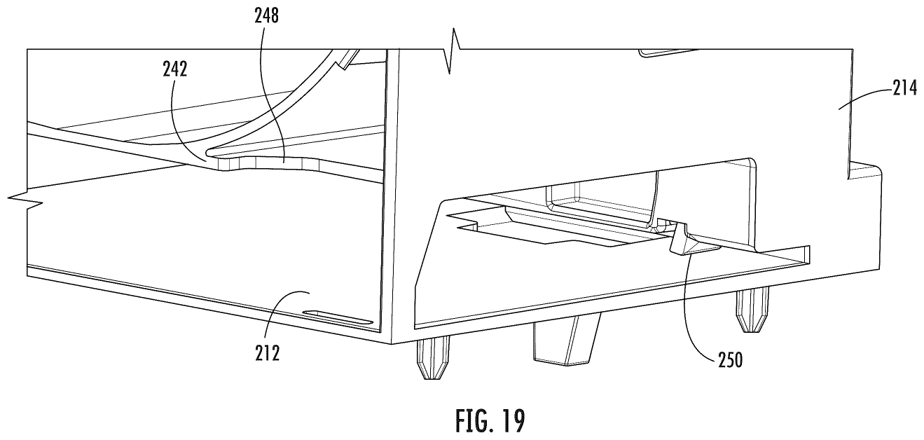

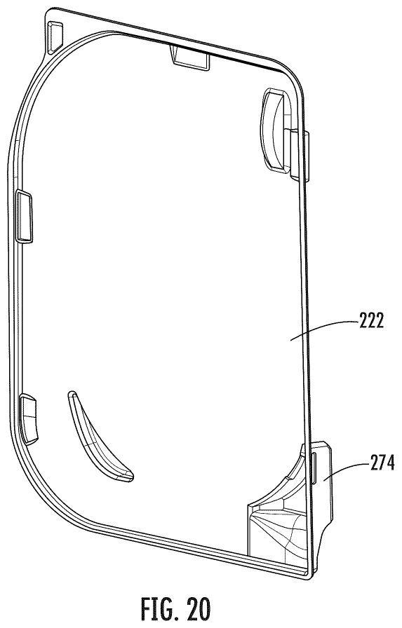

Referring now to FIG. 20, the cover 222 has a front tab 274 that is shaped somewhat differently. As can be seen in FIGS. 16 and 19, the pathway ceiling 242 has a notch 248 that receives the front tab 274 when the cover 222 is inserted. As a result, the “seam” formed at the location wherein the front tab 274 abuts the pathway ceiling 242 is a “vertical” seam, rather than being horizontal as is the case with the cartridge 10. Changing the orientation of the seam can help to reduce the risk that a pouch can “catch” on this interface.

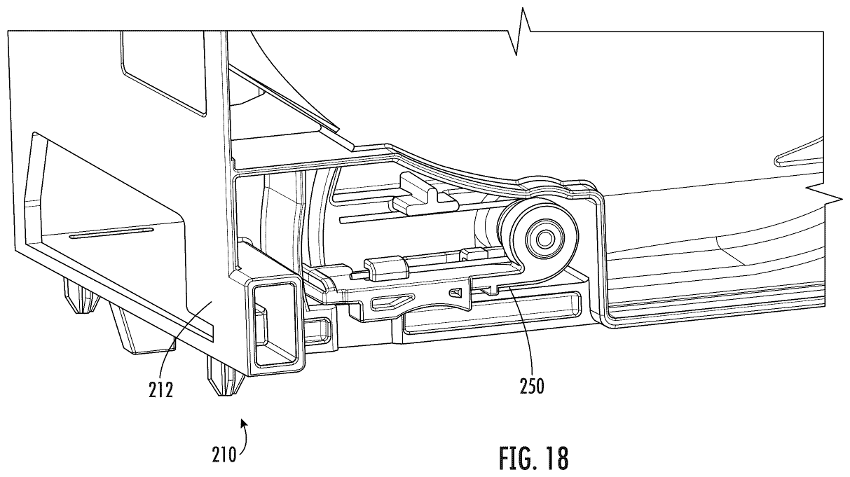

FIGS. 18 and 19 illustrate that the brake 250 differs slightly in configuration to accommodate the above-described changes in the guide system 230 and the cover 222.

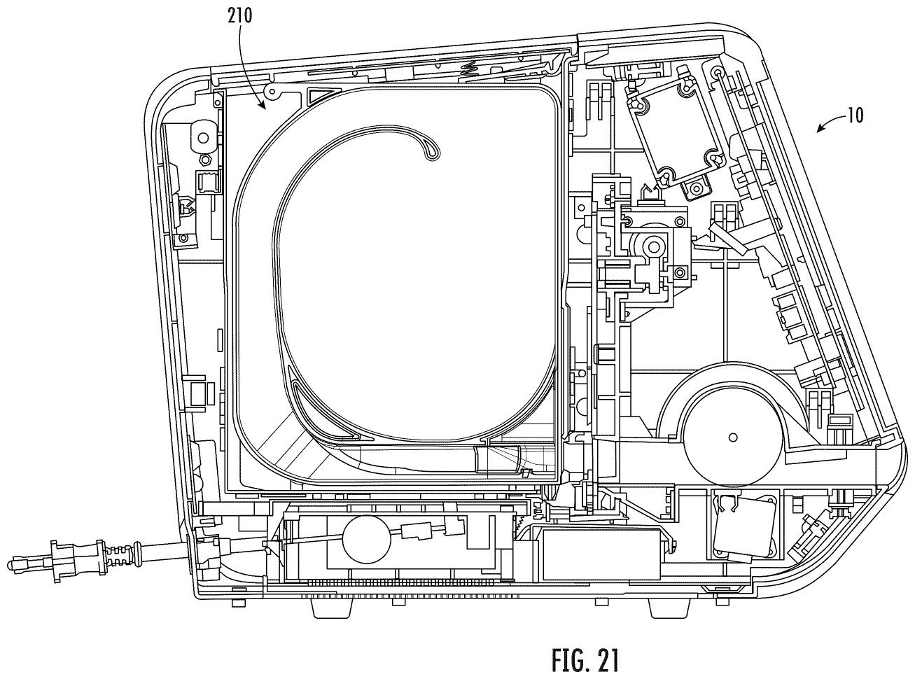

Loading of the cartridge 210 and operation of the system 100 with a loaded cartridge 210 proceed in the same manner described above for the cartridge 10 (see FIGS. 21-23).

Those of skill in this art will appreciate that the cartridge may take other forms. For example, the arc defined by the guide systems 30, 230 may be greater or less than that described; the bulbs 32, 232 may be of a different size, shape and/or angular disposition; and/or the bearing members 43, 243 may define a gap of a different size. Other variations will be apparent to those of skill in this art.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

What is claimed is:

1. A cartridge for pharmaceutical dispensing system, wherein the system is configured to dispense pouches containing medicaments, the pouches provided as a strip of a plurality of pouches, the strip provided in coiled form, the cartridge comprising:
a main receptacle having a floor, a ceiling, a front wall, a rear wall, and a first side wall, wherein the front wall includes a slot for dispensing pouches;
a cover that engages the main receptacle and provides a second side wall opposite the first side wall; and
a guide system disposed in the main receptacle, the guide system defining an interior space configured to hold the strip of pouches in coiled form, and further defining a pathway between the guide system and the ceiling, rear wall, and floor.

2. The cartridge defined in claim 1, wherein the floor includes an aperture that provides access for a drive wheel located below the floor to engage the strip as it is routed above the floor and to the slot in the front wall.

3. The cartridge defined in claim 1, further comprising a brake mounted to the main receptacle and extending into the pathway.

4. The cartridge defined in claim 3, wherein the brake is biased toward the floor.

5. The cartridge defined in claim 1, wherein the guide system includes a round-ended bulb at an upstream end thereof.

6. The cartridge defined in claim 5, wherein the bulb is disposed at an angle of between about 30 and 60 degrees relative to vertical.

7. The cartridge defined in claim 1, wherein the guide system includes an upper arcuate segment and a lower arcuate segment that define generally a 270 to 300 degree arc.

8. The cartridge defined in claim 7, wherein the guide system further includes a pathway ceiling positioned under the lower arcuate segment and generally parallel with the floor.

9. The cartridge defined in claim 8, further comprising a bearing member that underlies the pathway ceiling and overlies the floor.

10. The cartridge defined in claim 1, wherein the cover is configured to snap into the main receptacle.

11. The cartridge defined in claim 1, in combination with a coiled strip of pouches, each of the pouches holding one or more medicaments, the coiled strip pf pouches at least partially residing in the interior space of the guide system.

12. The combination defined in claim 11, wherein the coiled strip of pouches lacks a central axle member.

13. A cartridge for pharmaceutical dispensing system, wherein the system is configured to dispense pouches containing medicaments, the pouches provided as a strip of a plurality of pouches, the strip provided in coiled form, the cartridge comprising:
a floor, a ceiling, a front wall, a rear wall, and first and second sidewalls,
wherein the front wall includes a slot for dispensing pouches; and
a guide system disposed in the main receptacle, the guide system defining an interior space configured to hold the strip of pouches in coiled form, and further defining a pathway between the guide system and the ceiling, rear wall, and floor;
wherein the guide system includes a round-ended bulb at an upstream end thereof.

14. The cartridge defined in claim 13, wherein the bulb is disposed at an angle of between about 30 and 60 degrees relative to vertical.

15. The cartridge defined in claim 13, wherein the floor includes an aperture that provides access for a drive wheel located below the floor to engage the strip as it is routed above the floor and to the slot in the front wall.

16. The cartridge defined in claim 13, further comprising a brake mounted to the main receptacle and extending into the pathway.

17. The cartridge defined in claim 16, wherein the brake is biased toward the floor.

18. The cartridge defined in claim 13, in combination with a coiled strip of pouches, each of the pouches holding one or more medicaments, the coiled strip pf pouches at least partially residing in the interior space of the guide system.

19. The combination defined in claim 13, wherein the coiled strip of pouches lacks a central axle member.
